(19) United States
(12) Patent Application Publication
(10) Pub. No.: US 2017/0352085 A1
(43) Pub. Date: Dec. 7, 2017

(54) PART SELLING SYSTEM

(71) Applicant: SCREEN Holdings Co., Ltd., Kyoto (JP)

(72) Inventors: Tadashi FUKUDA, Kyoto-shi (JP); Keiji NISHIDA, Kyoto-shi (JP)

(21) Appl. No.: 15/596,656

(22) Filed: May 16, 2017

(30) Foreign Application Priority Data
Jun. 7, 2016 (JP) 2016-113564

(51) Int. Cl. G06Q 30/06; G06F 17/30

(52) U.S. Cl. CPC G06Q 30/0627; G06Q 30/0643; G06F 17/30864; G06F 17/3089

(57) ABSTRACT

A person in charge of a company, a user of a semiconductor manufacturing apparatus, uses an information terminal to log in via the Internet to a server of a part selling company selling, in an electronic shop, parts of the semiconductor manufacturing apparatus, and specifies a predetermined keyword for a part search. The person in charge specifies a sell-candidate part displayed as a search result, and requests detailed information to be displayed. A part information page generating unit of the server generates a web page describing the specified part's detailed information. The part information page generating unit describes in the web page at least a quantity of specified part's stocks in a nearby local warehouse to the user company. The part information page generating unit differentiates items to be described in a web page in accordance with a hierarchy of a person in charge of a user company.

### BACKGROUND OF THE INVENTION

### Field of the Invention

The present invention relates to a part selling system for selling parts of an industrial machine such as a semiconductor manufacturing apparatus in an electronic shop on the Internet.

Description of the Background Art

As widely known, a semiconductor device is produced by implementing to a semiconductor substrate a series of processes including cleaning, resist coating, exposure, development, etching, formation of an interlayer insulating film, and heat treatment. These processes are conventionally executed with a semiconductor manufacturing apparatus equipped with pluralities of processing units, transfer robots, and other equipment.

The semiconductor manufacturing apparatus described above is assembled with many parts including motors, pumps, valves, panels, lamps, and nozzles. Such parts configuring the semiconductor manufacturing apparatus also include consumables. Typical consumables include, for example, a cleaning brush used for cleaning the semiconductor substrate and light irradiation lamps. Different from consumables, many parts would no longer be used due to a failure or contamination.

Before a life expires or a failure occurs, such parts therefore have to be replaced so that the semiconductor manufacturing apparatus can well function. US2003/0046034 discloses a system where a period of use of a part or another parameter is measured to know a degree of consumption, and, upon the period of use exceeds a certain value, a new part for replacement is automatically ordered.

All parts would however not always fully function until each life expires, and some parts would malfunction due to a failure before its life expires. Some parts would not also be used due to a sudden, unexpected problem. For even a part that functions only partially in the semiconductor manufacturing apparatus, if the part malfunctions, a downtime would occur during which the whole semiconductor manufacturing apparatus is not available.

### SUMMARY OF THE INVENTION

The present invention is directed to a part selling system for selling parts of an apparatus in an electronic shop.

According to an aspect of the present invention, the part selling system includes: a part search unit for extracting a sell-candidate part in response to a part search request sent from a customer terminal used by a customer, a part information page generating unit for generating, in response to an information display request sent from the customer terminal with which a specified part is specified from the sell-candidate part, a web page including part information on the specified part, and for transmitting the web page to the customer terminal via a network, and a storage unit storing a warehouse database in which a plurality of warehouses owned by an apparatus provider, parts stored as stocks in the warehouses, and quantities of the stocks are associated with each other, where the part information page generating unit is configured to extract from the warehouse database and to describe in the web page a product name and a photograph of the specified part for which the information display request is sent from the customer terminal, together with a nearby warehouse to the customer in the plurality of warehouses and a quantity of stocks of the specified part in the nearby warehouse.

According to another aspect of the present invention, a part selling system includes: a part search unit for extracting a sell-candidate part in response to a part search request sent from a customer terminal used by a customer, a part information page generating unit for generating, in response to an information display request sent from the customer terminal with which a specified part is specified from the sell-candidate part, a web page including part information on the specified part, and for transmitting the web page to the customer terminal via a network, and a print data creating unit for creating, in response to an estimation request operated on the customer terminal, print data of an estimation on the specified part for which the information display request is sent from the customer terminal, and for transmitting the print data to the customer terminal.

According to still another aspect of the present invention, a part selling system includes: a part search unit for extracting a sell-candidate part in response to a part search request sent from a customer terminal used by a customer, a part information page generating unit for generating, in response to an information display request sent from the customer terminal with which a specified part is specified from the sell-candidate part, a web page including part information on the specified part, and for transmitting the web page to the customer terminal via a network, and a storage unit storing a customer database in which a customer and a hierarchy of the customer are associated with each other, where the part information page generating unit is configured to search for, in the customer database, a hierarchy of the customer who has used the customer terminal with which the information display request is sent, and to describe, in the web page, items on the specified part, which differ depending on the retrieved hierarchy.

A sell-candidate part is extracted in response to a part search request sent from a customer terminal used by a customer, and, in response to an information display request sent from the customer terminal with which a specified part is specified from the sell-candidate part, a web page including part information on the specified part is generated, and the web page is transmitted to the customer terminal via a network. A part selling system highly convenient to a user of an apparatus can therefore be achieved.

In view of the above description, the present invention has an object to provide a part selling system highly convenient to a user of an apparatus.

These and other objects, features, aspects and advantages of the present invention will become more apparent from the following detailed description of the present invention when taken in conjunction with the accompanying drawings.

### BRIEF DESCRIPTION OF THE DRAWING

FIG. 1 is a view illustrating an exemplary construction of a part selling system according to the present invention;

FIG. 2 is a block diagram illustrating a configuration of a server;

FIG. 3 is a flowchart illustrating an operating procedure of the part selling system;

FIG. 4 is a view illustrating an example of an account creation screen in the server;

FIG. 5 is a view illustrating an exemplary display of an alternative to a discontinued part; and

FIG. 6 is a view illustrating an example of a web page including detailed information on a specified part.

### DESCRIPTION OF THE PREFERRED EMBODIMENTS

A preferred embodiment of the present invention will now be described herein in detail with reference to the drawings.

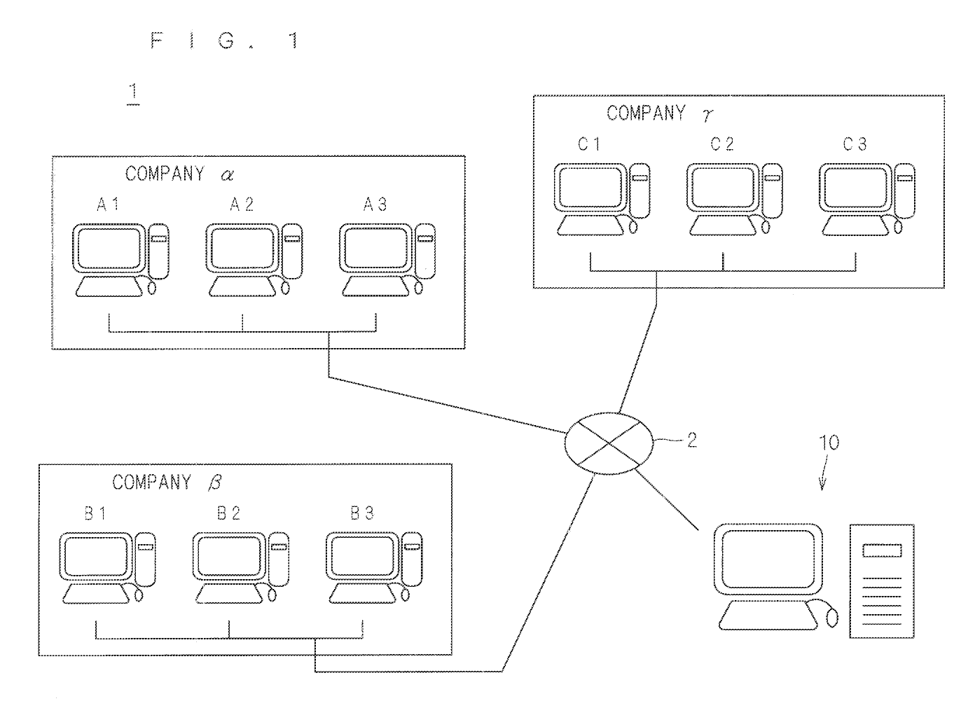

FIG. 1 is a view illustrating an exemplary construction of a part selling system according to the present invention. A part selling system 1 is, for example, a system for selling parts of a semiconductor manufacturing apparatus in an electronic shop on the Internet. The part selling system I is constructed by coupling via an Internet 2 a server 10 of a company selling parts of a semiconductor manufacturing apparatus (hereinafter, part selling company), and an information terminal such as a personal computer (PC) of a company who is a user of the semiconductor manufacturing apparatus (hereinafter, user company).

A plurality of persons in charge belongs to the user company. For example, in the example shown in FIG. 1, persons in charge A1, A2, and A3 belong to a company α, persons in charge B1, B2, and B3 belong to a company β, and persons in charge C1, C2, and C3 belong to a company γ. An information terminal is typically lent to each of persons in charge of a user company, and the information terminals are coupled each other via an in-house LAN, as well as externally coupled to the server 10 via the Internet 2. When the information terminals are personal computers, the information terminals may be desk-top or laptop personal computers. The information terminals are not limited to personal computers, but may be, for example, tablet terminals, as long as such a device can be coupled to the Internet 2.

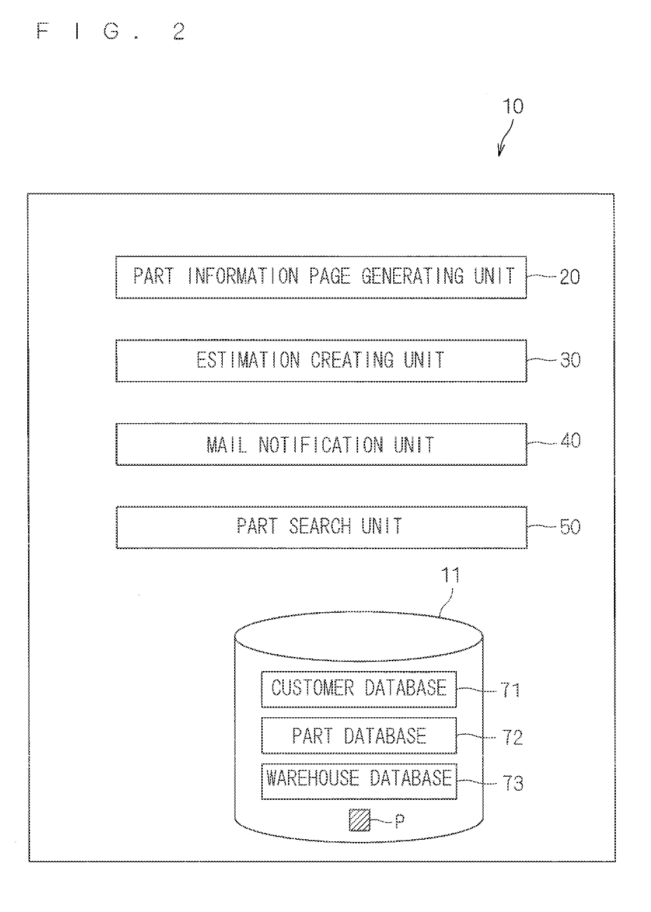

FIG. 2 is a block diagram illustrating a configuration of the server 10. A hardware configuration of the server 10 is similar or identical to a hardware configuration of an ordinary computer. That is, the server 10 is configured to include a central processing unit (CPU) that a circuit for performing various arithmetic processes, a read only memory (ROM) storing a basic program, a random access memory (RAM) for storing various information, into and from which data can freely be read and written, and a storage unit 11, such as a magnetic disc, for storing control software, data, and other information. In the storage unit 11, a computer program P is installed for achieving an electronic shop. A part information page generating unit 20, an estimation creating unit 30, a mail notification unit 40, and a part search unit 50 shown in FIG. 2 are function processing units achieved when the CPU of the server 10 executes the computer program P. Contents of operations of the function processing units will be described later. The storage unit 11 also stores a customer database (DB) 71, a part database 72, and a warehouse database 73.

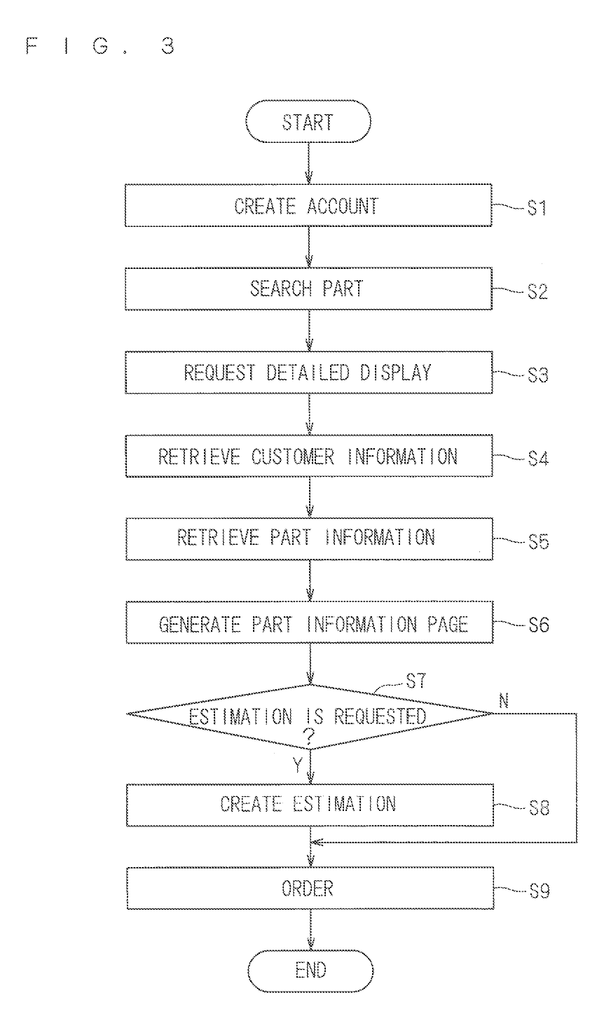

Next, an operating procedure and its content of the part selling system 1 will now be described herein. FIG. 3 is a flowchart illustrating the operating procedure of the part selling system 1. Before using the part selling system 1, a person in charge of a user company of a semiconductor manufacturing apparatus asks a part selling company for use of an electronic shop. Specifically, the person in charge of the user company visits a site of the electronic shop that is open on the Internet 2 through the server 10 to ask for a new account. At a time of application, the person in charge of the user company enters an authentication ID notified beforehand, a password, his or her e-mail address, and other information. A person in charge of the part selling company, who has accepted the application, creates an account (step S1). Each person in charge of a user company should ask a new account. For example, the person in charge A1 and the person in charge A2 both belonging to the company α should separately ask for a new account.

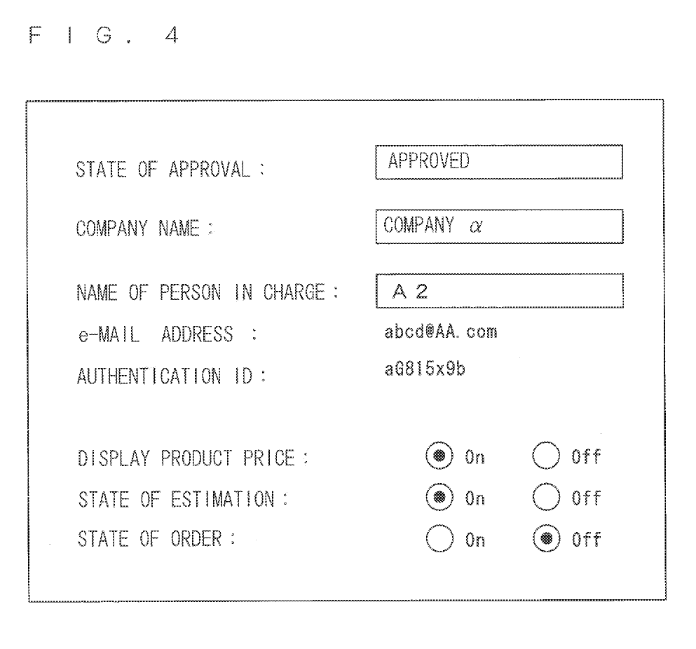

FIG. 4 is a view illustrating an example of an account creation screen in the server 10. This example shows a case when the person in charge A2 of the company α who is a user company asks for a new account. The account creation screen displays, in addition to a company name of the user company (company α) and a name of the person in charge (A2), a mail address and an authentication ID of the person in charge A2. Upon the person in charge of the part selling company sets a state of approval to “APPROVED” in the account creation screen, an account for the person in charge A2 of the company α is created in the server 10.

As shown in FIG. 4, the account creation screen displays on/off check buttons for three items of “DISPLAY PRODUCT PRICE”, “STATE OF ESTIMATION” and “STATE OF ORDER.” The three items should be set in accordance with a hierarchy of a person in charge of a user company. Various persons in charge having different privileges typically belong to a user company, such as a manager with authority, a site supervisor, a person in charge of part procurement, and a worker of an affiliated company. A worker of an affiliated company should not be notified with a price of a purchased part, information of which should be kept confidential. A site supervisor might often ask for an estimation on a part need to be purchased, but might not often be allowed to approve by himself or herself a purchase. Whereas, a manager with authority is often allowed to approve by himself or herself a purchase, and to order a part.

In the part selling system 1 according to the present invention, such various persons in charge are classified into four hierarchies when creating an account. Specifically, the four hierarchies include: a first hierarchy with which a product can be ordered, a second hierarchy with which an estimation can be requested, a third hierarchy with which a product price can be viewed, and a fourth hierarchy with which only a stock state of a product can be viewed. A person in charge classified into the fourth hierarchy is able to check a stock state of a part, but is neither able to view a price of the part, nor is obviously able to request an estimation and to place an order. A person in charge classified into the third hierarchy is able to view a stock state of a part and its price, but is neither able to request an estimation nor to place an order. A person in charge classified into the second hierarchy is able to view a stock state of a part and its price, and to request an estimation, but is not able to finally order the part. A person in charge classified into the first hierarchy is able to use all functions including ordering a part.

The person in charge of the part selling company sets, in the account creation screen, a person in charge of a user company who has asked for a new account into one of the above described four hierarchies. To set a person in charge of a user company to the first hierarchy, the person in charge of the part selling company sets “On” for all of “DISPLAY PRODUCT PRICE,” “STATE OF ESTIMATION,” and “STATE OF ORDER.” To set a person in charge of a user company to the second hierarchy, the person in charge of the part selling company sets “On” for two items of “DISPLAY PRODUCT PRICE” and “STATE OF ESTIMATION,” but sets “Off” for “STATE OF ORDER.” To set a person in charge of a user company to the third hierarchy, the person in charge of the part selling company sets “On” for “DISPLAY PRODUCT PRICE” only, but sets “Off” for “STATE OF ESTIMATION,” and “STATE OF ORDER.” To set a person in charge of a user company to the fourth hierarchy, the person in charge of the part selling company sets “Off” for all of “DISPLAY PRODUCT PRICE,” “STATE OF ESTIMATION,” and “STATE OF ORDER.” In the example shown in FIG. 4, the person in charge A2 of the company α is set to the second hierarchy. A hierarchy to be set to a person in charge of a user company who has asked for a new account may be determined based on a content of application, such as a job title at a time of the application, or based on customer information collected by the part selling company.

Upon the person in charge of the part selling company sets a state of approval to “APPROVED” in the account creation screen, an account for the person in charge of the user company who has asked for a new account is created. Upon the account is created, a company name, a name of the person in charge, an e-mail address, a hierarchy, and other information of the person in charge of the user company who has asked for a new account are associated with each other, and registered in the customer database 71.

Upon the account for the person in charge of the user company is created, the person in charge of the user company can use the electronic shop achieved by the part selling system 1. When the electronic shop is used, the person in charge of the user company logs in to the site of the electronic shop, and searches for a part desired to be purchased (step S2). To search for the part, the person in charge enters in a search screen of the site, as a keyword, a product name code or a product name of the part desired to be purchased. To search for the part, the person in charge may enter, as a keyword, a standard name or a text included in a product description. The person in charge may also search for the part with a model name of a semiconductor manufacturing apparatus equipped with the part desired to be purchased, or a price range.

Upon the person in charge of the user company specifies a keyword and sends a search request, the part search unit 50 of the server 10 executes a search process for the part desired to be purchased by the person in charge of the user company to the part database 72 stored in the storage unit 11. In the part database 72, a product name, a product name code, a standard price, a standard, a product description, an applicable model name, photograph data, and other information of the part are associated with each other and registered. The part search unit 50 includes a search engine that extracts, from the part database 72, as a sell-candidate part, a part that satisfies the keyword specified by the person in charge of the user company. A keyword and a part may not always fully match each other, but may partially match. The product name of the part and other information extracted by the part search unit 50 are transmitted as a sell-candidate part to the information terminal of the person in charge of the user company, who has sent the search request. The information terminal of the person in charge displays simple information including a product name, a photograph, a product name code, and other information of the sell-candidate part extracted as a search result. When a plurality of sell-candidate parts is extracted as a search result, the sell-candidate parts are shown in a list format on the information terminal of the person in charge.

Some parts of the semiconductor manufacturing apparatus might sometimes be discontinued, and such parts thus are not purchasable. When a sell-candidate part extracted as a search result by the part search unit 50 is a discontinued part, the part selling system 1 according to the present invention transmits, together with a product name and other information of the discontinued part, a product name and other information of an alternative, as another sell-candidate part, to the information terminal of the person in charge of the user company.

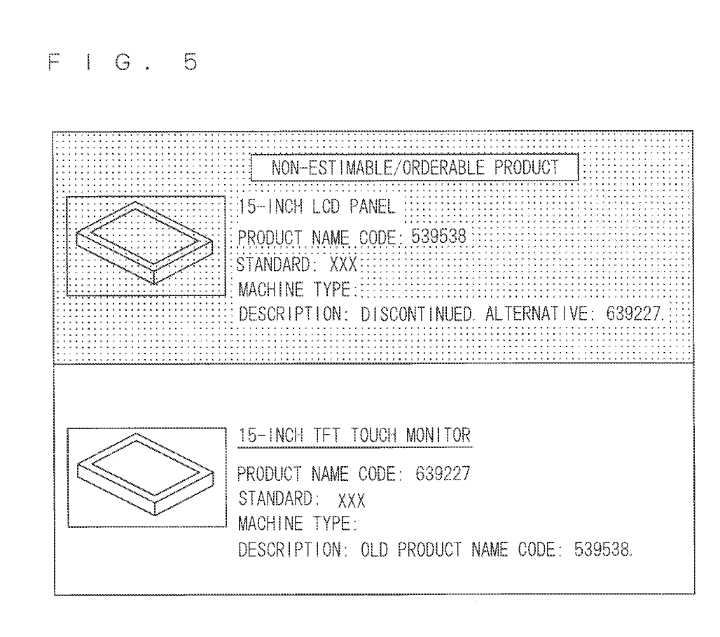

FIG. 5 is a view illustrating an exemplary display of an alternative to a discontinued part. In this example, when a person in charge of a user company has specified a product name code “539538” and has executed a search request, a corresponding part that is a 15-inch LCD panel has already been discontinued, the part search unit 50 therefore transmits, together with the product name code and other information of the 15-inch LCD panel, a product name code “639227” and other information of an alternative that is a 15-inch TFT touch monitor, as another sell-candidate part, to an information terminal of the person in charge. The information terminal of the person in charge displays in parallel, as shown in FIG. 5, the 15-inch LCD panel that is the discontinued part and the 15-inch TFT touch monitor that is the alternative. For a discontinued part, an indication of non-estimable/orderable product is displayed, as well as a product name code of an alternative is displayed. For the alternative, a product name code of the old part is also displayed. To achieve such a function, the part database 72 is registered with a determination of whether a part is discontinued, as well as is registered with an associated product name code of an alternative to a discontinued part.

Next, the person in charge of the user company who has viewed the sell-candidate parts displayed on the information terminal specifies one of the sell-candidate parts on the information terminal, and performs, to the server 10, a display request for detailed information on the part (hereinafter, specified part) (step S3). In response to a request operated on the information terminal, the part information page generating unit 20 of the server 10 generates a web page including detailed information on the part specified by the person in charge of the user company, and transmits the web page to the information terminal. At this time, the part information page generating unit 20 retrieves customer information (step S4). Specifically, the part information page generating unit 20 searches for and retrieves from the customer database 71 customer information including a hierarchy and other information of the person in charge of the user company who has operated the request for detailed information.

The part information page generating unit 20 then retrieves part information (step S5). The part information page generating unit 20 retrieves from the part database 72 part information on the part specified by the person in charge of the user company. The part information page generating unit 20 then generates, based on the retrieved part information, a web page including detailed information on the specified part (hereinafter, detailed information web page) (step S6). The generated detailed information web page is transmitted by the part information page generating unit 20 via the Internet 2 to the information terminal of the person in charge of the user company, and is displayed on a screen of the information terminal.

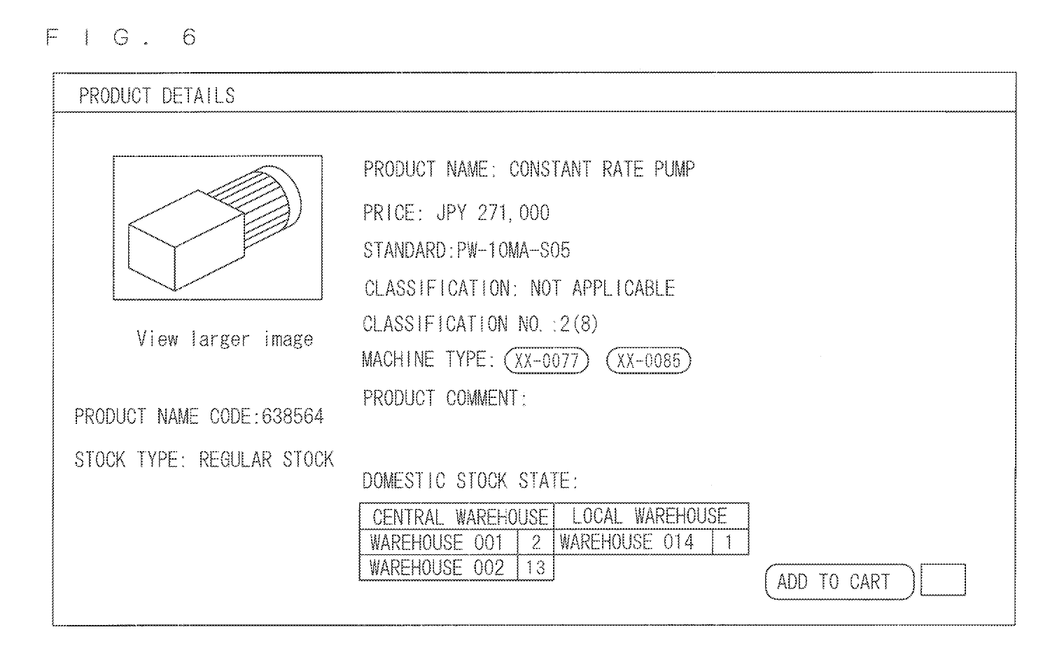

FIG. 6 is a view illustrating an example of web page including detailed information on a specified part. This detailed information web page includes a product name, a price, a standard, a product name code, a product comment, a photograph, and other information on the part specified by the person in charge of the user company. In the example shown in FIG. 6, the detailed information web page displays a price. However, whether a price is described in a detailed information web page depends on a hierarchy of a person in charge of a user company, who has sent a display request for detailed information. As described above, although persons in charge classified into the first to third hierarchies are able to view a price of a part, a person in charge classified into the fourth hierarchy is not able to view the price of the part. The part information page generating unit 20 thus describes a price in a detailed information web page when a hierarchy of a person in charge of a user company, who has sent a display request for detailed information, is one of the first to third hierarchies, but, when a hierarchy of a person in charge of a user company is the fourth hierarchy, the part information page generating unit 20 does not describe a price item in a detailed information web page. That is, the part information page generating unit 20 describes, in a detailed information web page, items on a specified part, which differ depending on a hierarchy of a person in charge of a user company, who has sent a display request for detailed information.

For a photograph described in a detailed information web page, when “View larger image” is selected, image data is enlarged and displayed on a screen of the information terminal. A photograph may be captured together with a ruler so that a size of a target part can easily be recognized.

For a price, a price of a part, which differs per user company, is described. That is, for a standard price of a part, which is registered in the part database 72, a discount rate is set to the standard price per user company. A discount rate differs per user company. For example, for a product name “constant rate pump,” different discount rates are set to company α and company β. Based on the customer information retrieved in step S4, the part information page generating unit 20 describes, in a detailed information web page, a price obtained by multiplying a standard price of a specified part with a discount rate. When a user company is a corporation body located in another country than Japan, a detailed information web page describes a price in a currency of the country, to which an exchange rate is applied. For example, when a user company is a corporation body located in the US, a detailed information web page describes a price in the US dollar, to which a JPY/US dollar exchange rate is applied. As described above, a detailed information web page describes a price of a specified part, which differs per user company.

A detailed information web page also describes a classification and a classification No. with respect to a security trade control. This information is also registered in the part database 72.

As shown in FIG. 6, a detailed information web page also describes a stock type of a specified part. Specifically, a detailed information web page describes whether a specified part is a “REGULAR STOCK” or a “PART TO BE ORDERED AS REQUIRED.” A “REGULAR STOCK” is a part that a part selling company always stores as a stock regardless of whether an order is placed. For regular stocks, there is a stock basically. However, there is no stock in a rare case. For regular stocks, if there is no stock, a stock will be supplied within a shorter period of time. A frequently ordered part is specified as a regular stock.

On the other hand, a “PART TO BE ORDERED AS REQUIRED” is a part that is ordered by a part selling company to a part manufacturer each time a customer places an order. For parts to be ordered as required, there is no stock basically (there is a stock in a rare case). A less-frequently ordered part is specified as a part to be ordered as required. By describing in a detailed information web page whether a specified part is “REGULAR STOCK” or “PART TO BE ORDERED AS REQUIRED,” a person in charge of a user company is able to roughly know when the specified part will be delivered after he or she places an order.

In addition to the above described stock type, when a specified part is a specially ordered part that is unique to a user company, a detailed information web page may describe about that specification. The part search unit 50 does not suggest a specially ordered part as a sell-candidate part to other customers than a user company who uses the specially ordered part, even though a search keyword matches when a search request to a part is sent in step S2. Information on a specially ordered part is therefore prevented from leaking externally to other companies than a user company who uses the specially ordered part.

A detailed information web page also describes a machine type equipped with a part specified by a person in charge of a user company. Parts highly widely used are often commonly used in a plurality of models. Describing a machine type equipped with a specified part on a detailed information web page is advantageous for an appropriate stock control in a user company.

As shown in FIG. 6, the part information page generating unit 20 further describes, in a detailed information web page, a stock state of a specified part in a warehouse. A part selling company might own some warehouses for storing parts per country in which a user company locates. Such warehouses include a central warehouse that is a center for controlling stock parts and a local warehouse built near a factory or another facility of a user company. Parts stored as stocks in each warehouse and quantities are registered in the warehouse database 73. When a display request for detailed information is sent, the part information page generating unit 20 retrieves from the warehouse database 73 information on warehouses storing stocks of a specified part with a quantity of the stocks of the specified part. The part information page generating unit 20 describes in a detailed information web page, among a plurality of warehouses located in a country in which a user company locates, a nearby local warehouse to the user company, and a quantity of stocks of a specified part in the local warehouse. In the example shown in FIG. 6, the detailed information web page describes, in addition to a local warehouse, quantities of stocks of a specified part in central warehouses. Since a stock state in a warehouse changes day by day, the warehouse database 73 should advantageously be updated at least once per day.

A part stored in a nearby local warehouse to a user company will likely be delivered promptly to the user company. That is, by describing in a detailed information web page at least a quantity of stocks of a specified part in a nearby local warehouse to a user company, a person in charge of the user company is able to easily predict when the specified part will be delivered.

Next, the person in charge of the user company who has viewed the detailed information web page displayed on the information terminal determines whether he or she requests an estimation to the specified part (step S7). To request an estimation, the person in charge operates an estimation request on the information terminal. In response to the estimation request operated on the information terminal, the estimation creating unit 30 of the server 10 creates print data (for example, pdf data) of an estimation to the above described specified part specified by the person in charge of the user company, and transmits the print data to the information terminal (step S8). The estimation creating unit 30 creates an estimation to the specified part in a form identical to a form of an official estimation issued by the part selling company. The person in charge of the user company is therefore able to print out the received print data, and to use the printout as an official estimation for in-house approval. Since the estimation creating unit 30 of the server 10 automatically creates an estimation in response to an estimation request, a person in charge of the part selling company is able to save time and effort for issuing an estimation. Persons in charge classified into the first and second hierarchies are only able to request an estimation.

When an estimation request is operated on an information terminal, the mail notification unit 40 of the server 10 transmits an e-mail to a certain person in charge of the part selling company to notify that the estimation request has been received. When an estimation request is received from a customer, a specified part would then likely be ordered in many cases. With a notification that an estimation request has been received, a person in charge of the part selling company is therefore able to prepare the specified part to be delivered before the customer places an order. If only an estimation request is received, but a specified part is not ordered, it can be considered that a similar or identical part is likely ordered to another company. Such a fact can be utilized for marketing research.

A person in charge of a user company who has determined to purchase a specified part after an estimation is received or without requesting an estimation operates the information terminal to place an order (step S9). Upon the information terminal is operated and an order is placed, the server 10 notifies that an order has been placed to a person in charge of the part selling company. The person in charge of the part selling company performs a delivery process for the specified part to the user company. A person in charge classified to the first hierarchy is only able to place an order.

The preferred embodiment of the present invention has been described above. However, the present invention can variously be altered to other embodiments than the embodiment described above without departing from the scope of the present invention. For example, in the above described preferred embodiment, to allow a user company to predict when a part will be delivered, a detailed information web page has described at least a quantity of stocks of a specified part in a nearby local warehouse to the user company. However, in addition to such a quantity, a standard number of days for delivery to the user company may advantageously be described.

In the above described preferred embodiment, when a stock type of a specified part is a part to be ordered as required, a standard number of days until the specified part is delivered to the user company may further advantageously be described.

A detailed information web page may describe a purchase history of a specified part purchased by other persons in charge of a user company to which a person in charge who has sent a display request of detailed information on the specified part belongs. With a web page as described above, a part is prevented from being ordered in a duplicated manner from a user company, and parts can be controlled under an appropriate stock control.

Target parts to be sold through the part selling system 1 according to the present invention are not limited to parts of a semiconductor manufacturing apparatus, but may be parts of another industrial machine.

While the invention has been shown and described in detail, the foregoing description is in all aspects illustrative and not restrictive. It is therefore understood that numerous modifications and variations can be devised without departing from the scope of the invention.

What is claimed is:

1. A part selling system for selling parts of an apparatus in an electronic shop, comprising:
a part search unit for extracting a sell-candidate part in response to a part search request sent from a customer terminal used by a customer;
a part information page generating unit for generating, in response to an information display request sent from said customer terminal with which a specified part is specified from said sell-candidate part, a web page including part information on said specified part, and for transmitting the web page to said customer terminal via a network; and
a storage unit storing a warehouse database in which a plurality of warehouses owned by an apparatus provider, parts stored as stocks in the warehouses, and quantities of the stocks are associated with each other,
wherein said part information page generating unit is configured to extract from said warehouse database and to describe in said web page a product name and a photograph of said specified part for which the information display request is sent from said customer terminal, together with a nearby warehouse to said customer in said plurality of warehouses and a quantity of stocks of said specified part in the nearby warehouse.

2. A part selling system for selling parts of an apparatus in an electronic shop, comprising:
a part search unit for extracting a sell-candidate part in response to a part search request sent from a customer terminal used by a customer;
a part information page generating unit for generating, in response to an information display request sent from said customer terminal with which a specified part is specified from said sell-candidate part, a web page including part information on said specified part, and for transmitting the web page to said customer terminal via a network; and
a print data creating unit for creating, in response to an estimation request operated on said customer terminal, print data of an estimation on said specified part for which the information display request is sent from said customer terminal, and for transmitting the print data to said customer terminal.

3. A part selling system for selling parts of an apparatus in an electronic shop, comprising:
a part search unit for extracting a sell-candidate part in response to a part search request sent from a customer terminal used by a customer;
a part information page generating unit for generating, in response to an information display request sent from said customer terminal with which a specified part is specified from said sell-candidate part, a web page including part information on said specified part, and for transmitting the web page to said customer terminal via a network; and
a storage unit storing a customer database in which a customer and a hierarchy of the customer are associated with each other,
wherein said part information page generating unit is configured to search for, in said customer database, a hierarchy of the customer who has used the customer terminal with which the information display request is sent, and to describe, in said web page, items on said specified part, the items differing depending on the retrieved hierarchy.

4. The part selling system according to claim 1, wherein said part information page generating unit is configured to describe in said web page whether said specified part for which the information display request is sent from said customer terminal is a regular stock or a part to be ordered as required.

5. The part selling system according to claim 1, wherein said part information page generating unit is configured to describe in said web page a price of said specified part, the price being different by the customer who has used the customer terminal with which the information display request is sent.

6. The part selling system according to claim 1, wherein said part information page generating unit is configured to describe in said web page a machine type of an apparatus equipped with said specified part for which the information display request is sent from said customer terminal.

7. The part selling system according to claim 1, wherein said part information page generating unit is configured to describe in said web page a purchase history of said specified part purchased by other customers belonging to an organization to which the customer who has used the customer terminal with which the information display request is sent belongs.

8. The part selling system according to claim 1, wherein said part search unit is configured to, when said specified part for which the information display request is sent from said customer terminal is discontinued, extract an alternative to the specified part as a sell-candidate part.

9. The part selling system according to claim 2, further comprising a notification unit for notifying, when an estimation request is operated on said customer terminal, to a person in charge of a part provider, that the estimation request is received.
